(19) United States
(12) Patent Application Publication
(10) Pub. No.: US 2026/0056857 A1
(43) Pub. Date: Feb. 26, 2026

(54) Lane Margin Testing Method and Related Non-Transitory Computer-Readable Storage Medium

(71) Applicant: Wiwynn Corporation, New Taipei City (TW)

(72) Inventor: Yi-Hung Chiu, New Taipei City (TW)

(73) Assignee: Wiwynn Corporation, New Taipei City (TW)

(21) Appl. No.: 19/193,926

(22) Filed: Apr. 29, 2025

(30) Foreign Application Priority Data
Aug. 23, 2024 (TW) 113131699

(51) Int. Cl. G06F 11/273

(52) U.S. Cl. CPC G06F 11/2733

(57) ABSTRACT

A lane margin testing method for testing a plurality of Peripheral Component Interconnect Express (PCIe) lanes of an electronic system includes storing test software in a non-transitory computer-readable storage medium of the electronic system; generating a plurality of instruction files based on information of the plurality of PCIe lanes and storing the plurality of instruction files in the non-transitory computer-readable storage medium, wherein each of the plurality of instruction files includes a plurality of test instructions for a corresponding PCIe lane; and generating an auto-run file based on the plurality of instruction files and storing the auto-run file in the non-transitory computer-readable storage medium, wherein the auto-run file is used to instruct the test software to execute the plurality of test instructions recorded in each instruction file of the plurality of instruction files.

### BACKGROUND OF THE INVENTION

### 1. Field of the Invention

The present invention relates to a lane margin testing method and a related non-transitory computer-readable storage medium, and more particularly, to a lane margin testing method and a related non-transitory computer-readable storage medium capable of efficiently conducting signal integrity testing.

### 2. Description of the Prior Art

As signal transmission speeds continue to increase, and chip, packaging, and passive component designs become more complex, signal transmission systems may encounter potential issues such as reflection, distortion, delay, crosstalk, and impedance mismatch, leading to degradation of signal quality. As a result, signal integrity testing has become an indispensable part of the electronic product design and development process. For example, high-speed Peripheral Component Interconnect Express (PCIe) devices or equipment include transmitters and receivers, enabling full-duplex communication with other PCIe devices or equipment through links. Each link consists of one or more lanes, and each lane contains two pairs of differential signal lines for sending and receiving data. Since PCIe devices or equipment need to operate at high frequencies and high data transfer rates, the stability and reliability of their lanes are crucial. Therefore, signal integrity testing is necessary to help engineers identify potential problem points and make corrections before the product is launched.

Consequently, finding ways to conduct signal integrity testing efficiently has become one of the industry's primary objectives.

### SUMMARY OF THE INVENTION

Therefore, the present invention provides a lane margin testing method and a related non-transitory computer-readable storage medium for efficiently conducting signal integrity testing.

An embodiment of the present invention discloses a lane margin testing method for testing a plurality of Peripheral Component Interconnect Express (PCIe) lanes of an electronic system, which comprises storing test software in a non-transitory computer-readable storage medium of the electronic system; generating a plurality of instruction files based on information of the plurality of PCIe lanes and storing the plurality of instruction files in the non-transitory computer-readable storage medium, wherein each instruction file of the plurality of instruction files comprises a plurality of test instructions for a corresponding PCIe lane; and generating an auto-run file based on the plurality of instruction files and storing the auto-run file in the non-transitory computer-readable storage medium, wherein the auto-run file is used to instruct the test software to execute the plurality of test instructions recorded in each instruction file of the plurality of instruction files.

Another embodiment of the present invention discloses a non-transitory computer-readable storage medium, for testing a plurality of Peripheral Component Interconnect Express (PCIe) lanes of an electronic system, wherein the non-transitory computer-readable storage medium is accessed by at least a processor, and stores test software; a plurality of instruction files, wherein the plurality of instruction files are generated based on information of the plurality of PCIe lanes, and each instruction file of the plurality of instruction files comprises a plurality of test instructions for a corresponding PCIe lane; and an auto-run file, wherein the auto-run file is generated based on the plurality of instruction files, and the auto-run file is used to instruct the test software to execute the plurality of test instructions recorded in each instruction file of the plurality of instruction files.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a lane margin testing process according to an embodiment of the present invention.

FIG. 2 is a schematic diagram of a server system according to an embodiment of the present invention.

FIG. 3 is a schematic diagram of an electronic device according to an embodiment of the present invention.

### DETAILED DESCRIPTION

Certain terms are used throughout the description and following claims to refer to particular components. As one skilled in the art will appreciate, hardware manufacturers may refer to a component by different names. This document does not intend to distinguish between components that differ in name but not function. In the following description and in the claims, the terms “include” and “comprise” are utilized in an open-ended fashion, and thus should be interpreted to mean “include, but not limited to . . . ”. Also, the term “substantially” refers to being within an acceptable margin of error, where a person with ordinary skill in the art may solve the technical problem within a certain margin of error and essentially achieve the intended technical effect.

For signal integrity testing of PCIe lanes, the industry has developed many testing tools. For example, Intel® provides a Lane Margin Tool (LMT) software specifically for lane margin testing of PCIe links, which supports Python programming language interpreter. When performing tests, an operator needs to store the LMT software in the electronic system to be tested, open a command line or terminal with administrator privileges, launch the programming language interpreter (e.g., Python 3.8.10 or 3.10.6—64-bit version), and then execute multiple preset Python commands. The LMT software documentation provides templates for command content, allowing operator to modify relevant variables based on testing requirements, such as the lane number to be tested, Bus Device Function (BDF) identifier, margin test speed, test result name, receiver number, etc., to accordingly scan devices or initiate tests. It should be noted that the LMT software testing tool provided by Intel® only supports testing a single receiver (i.e., a single receiving direction) at a time and is limited to sequentially testing each lane to be tested. Moreover, for each test, the operator needs to check or modify various variables according to the receiver to be tested and its corresponding lane. In this scenario, if multiple PCIe devices or equipment require testing, the operator needs to constantly monitor the test status and re-enter commands to test lanes corresponding to different receivers. After the test is completed, the test results are scattered across the result folder, requiring the operator to manually search for and consolidate them. Therefore, as the number of test results increases, the difficulty of management also increases.

In short, although the LMT software testing tool provided by Intel® includes Python commands and related variable definitions required for testing, each test still heavily relies on the operator's expertise and experience to carefully configure multiple variables within the testing tool. Additionally, the operator needs to spend significant time and effort consolidating test results. This process is not only time-consuming and labor-intensive, but also involves a complex operation that increases the risk of human error, thereby resulting in low overall testing efficiency.

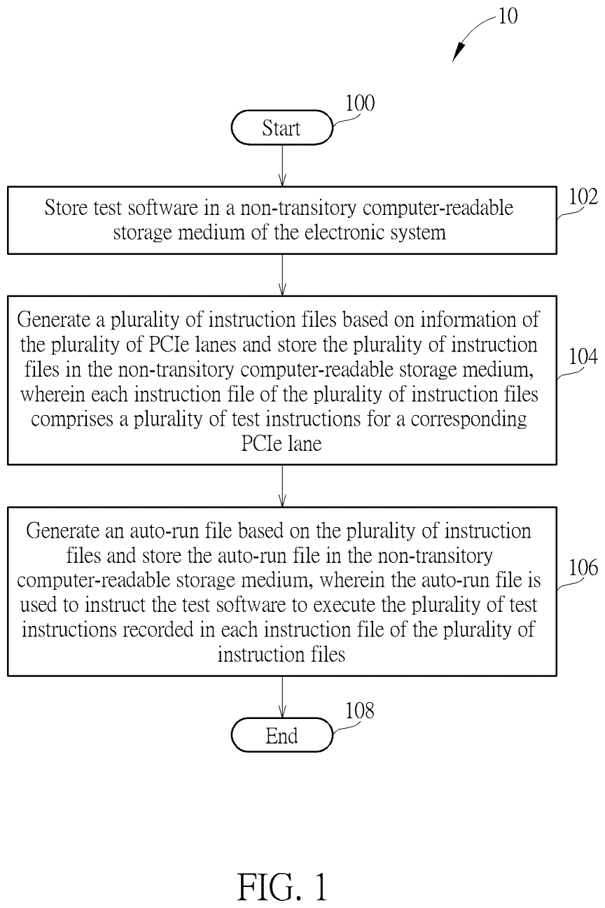

To improve the efficiency of signal integrity testing for PCIe lanes, the present invention provides a lane margin testing process 10, as shown in FIG. 1. The lane margin testing process 10 is used to test a plurality of PCIe lanes in an electronic system. It may automatically perform signal integrity testing on the PCIe lanes and systematically obtain the corresponding test results. The electronic system may be a computer system, a server, or other information systems that use PCIe architecture. The cooling methods for servers may be air-cooled, liquid-cooled, or other methods, and their architectures may be tower, rack-mounted, blade, or other types, but are not limited thereto. The lane margin testing process 10 includes the following steps:

Step 100: Start.

Step 102: Store test software in a non-transitory computer-readable storage medium of the electronic system.

Step 104: Generate a plurality of instruction files based on information of the plurality of PCIe lanes and store the plurality of instruction files in the non-transitory computer-readable storage medium, wherein each instruction file of the plurality of instruction files comprises a plurality of test instructions for a corresponding PCIe lane.

Step 106: Generate an auto-run file based on the plurality of instruction files and store the auto-run file in the non-transitory computer-readable storage medium, wherein the auto-run file is used to instruct the test software to execute the plurality of test instructions recorded in each instruction file of the plurality of instruction files.

Step 108: End.

According to the lane margin testing process 10, when signal integrity testing is to be performed on a plurality of PCIe lanes in the electronic system, the operator first stores test software in the non-transitory computer-readable storage medium of the electronic system (step 102). Then, based on the information of the PCIe lanes to be tested, corresponding instruction files are generated and stored in the non-transitory computer-readable storage medium (step 104). Finally, an auto-run file is generated (step 106), which is used to instruct the test software to execute a plurality of test instructions recorded in each instruction file. In other words, the lane margin testing process 10 of the embodiment of the present invention generates corresponding instruction files based on the information of each PCIe lane to be tested, and then uses the auto-run file to instruct the test software to execute the test instructions in various instruction files.

In detail, step 102 stores the test software in the non-transitory computer-readable storage medium of the electronic system. Preferably, the test software is the LMT software provided by Intel®, which supports Python programming language interpreter. Correspondingly, the instruction files generated in step 104 may be text files used to store Python code, meaning that the recorded test instructions conform to Python programming language syntax, while the auto-run file generated in step 106 can execute Python commands. For example, the LMT software provided by Intel® only allows single unidirectional testing at a time. Therefore, for the same PCIe lane, in one embodiment, step 104 may generate a single instruction file that includes test instructions to first perform a unidirectional test on the PCIe lane and then perform a reverse test. This enables tests that would otherwise require two separate performances to be completed in a single test, thereby simplifying the operation process and improving testing efficiency. Alternatively, in another embodiment, step 104 may generate two instruction files that include test instructions for performing forward and reverse tests on the PCIe lane, respectively, and then use the auto-run file generated in step 106 to separate the execution times of the two instruction files and automatically execute them sequentially. In other words, the operator may prepare instruction files for each PCIe lane before the test begins, reducing the workload of monitoring test status and re-entering commands during the testing process. Furthermore, the instruction files generated in step 104 may also include generating at least one corresponding test result file and may allow the operator to configure parameters, such as storage location and file name. This means that the operator may systematically preset the storage location, file name, etc., of each test result file before the test execution, enabling test results to be automatically stored in organized and predefined locations during the test process, allowing convenient retrieval of test results from preset locations after the test is completed, thereby reducing the operational complexity, management difficulty, and human error rate in consolidating test results.

After generating the instruction files in step 104, step 106 may generate the auto-run file accordingly, which may execute the test instructions recorded in each instruction file in a predetermined manner. It should be noted that step 104 generates the instruction files based on the interpreter supported by the test software, while the auto-run file generated in step 106 is executed by the electronic system. Therefore, a compatible mode of operation is selected based on the operating system of the electronic system, so as to instruct the test software to execute the test instructions recorded in each instruction file. For example, in one embodiment, if the operating system of the electronic system is Linux or Unix, the auto-run file may use a “screen” command to create multiple sessions, each executing the test instructions recorded in the respective instruction files. In Linux or Unix systems, the “screen” command acts as a terminal multiplexer, which can create multiple virtual terminals in a single terminal window and execute several independent sessions in the background to complete the lane margin tests corresponding to each instruction file. Furthermore, since lane margin testing for PCIe links requires executing multiple instruction files and takes a long time, in another embodiment, the auto-run file may also use the “screen -dms [session name] [command]” command, which creates a new detached session and executes the specified command within it. For example, a “screen -dms my_session python my_script.py” command would create a new session named “my_session”, execute “python my_script.py” in the background, and immediately return to the current terminal. Accordingly, the auto-run file may automatically synchronize the execution of test instructions for each instruction file in the background, effectively reducing the time required to wait for one instruction file to finish executing before starting the next. This may also reduce the process of monitoring the execution status of each instruction file one by one and manually executing each instruction file. In another embodiment, the auto-run file may be configured to execute the test instructions of each instruction file sequentially at a fixed time interval, which also falls within the scope of the present invention.

In addition, while the auto-run file is executing the test instructions of various instruction files in the background, the embodiment of the present invention may also display the test progress in the current terminal, such as the number of lanes that have not completed testing, or generate a notification message when the test is completed, thereby allowing the operator to keep track of the test status. Moreover, before instructing the test software to execute the instruction files, the auto-run file may also execute a checking mechanism, such as checking whether the number of PCIe lanes to be tested matches the number of instruction files generated in step 104, and may generate a warning signal if the numbers do not match.

Therefore, through the lane margin testing process 10, when testing a plurality of PCIe lanes in the electronic system is required, the operator only needs to prepare the instruction files for each PCIe lane to be tested before the test begins. By executing the auto-run file, the electronic system may automatically test multiple receivers and their corresponding lanes. During the testing process, there is no need to repeatedly check the test status of each PCIe lane or re-enter commands, allowing the testing of multiple receivers and their corresponding lanes to be completed efficiently, with the test results systematically obtained. Consequently, the embodiment of the present invention can improve the efficiency of PCIe lane margin testing, not only simplifying the operation process, shortening the time required for testing, and reducing labor-intensive tasks but also lowering the rate of human operational errors, and helping engineers identify potential problem points and make corrections before product launch.

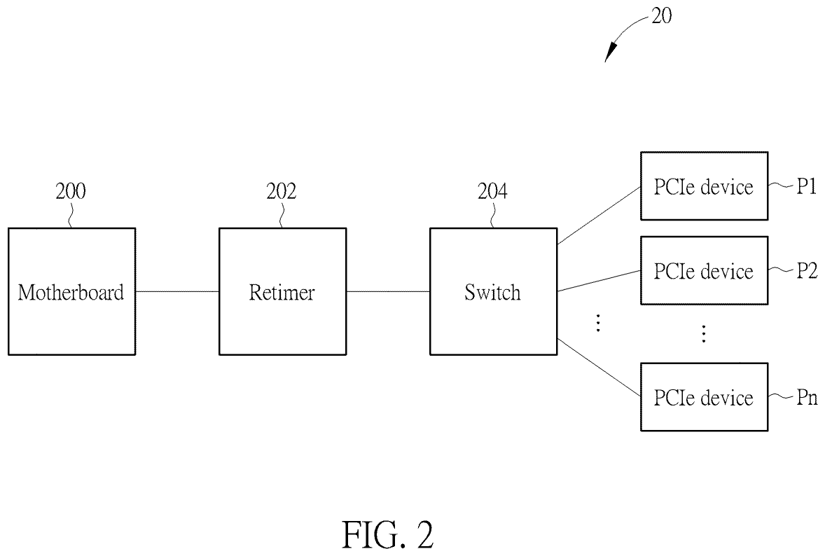

On the other hand, the implementation of the lane margin testing process 10 may depend on the architecture of the electronic system to which it is applied. For example, when applied to a server system, the lane margin testing process 10 may be implemented through built-in or external applications. Specifically, please refer to FIG. 2, which is a schematic diagram of a server system 20 according to an embodiment of the present invention. The server system 20 includes a motherboard 200, a retimer 202, a switch 204, and PCIe devices P1 to Pn, roughly representing the server architecture, which may be appropriately modified according to different applications. For instance, the retimer 202 and/or the switch 204 may be removed from the server system 20, or their quantities may be increased. The motherboard 200 is used to set up at least one processor, at least one non-transitory computer-readable storage medium, at least one network card, etc., and may connect to the PCIe devices P1 to Pn through the retimer 202 and the switch 204. The at least one processor may be a general-purpose processor, microprocessor, Application Specific Integrated Circuit (ASIC), etc., or a combination thereof. The at least one non-transitory computer-readable storage medium may be accessed by the at least one processor and may be Read-Only Memory (ROM), flash memory, Random Access Memory (RAM), hard disk, optical data storage device, and non-volatile storage unit, etc., but is not limited thereto. The retimer 202 may be a device used to improve the quality of high-speed data transmission signals, reducing signal distortion and jitter through signal processing technology, and be increased or decreased according to different needs or connected in series at other appropriate locations, which should be familiar to those skilled in the art. The switch 204 may be used for link expansion and distribution of signal transmission, enabling the motherboard 200 to establish connections with multiple PCIe devices.

In one embodiment, the operator may directly operate the server system 20 to execute the lane margin testing process 10, thereby testing the margins of a plurality of PCIe lanes. In other words, the operator may operate the server system 20 to store test software in the non-transitory computer-readable storage medium of the server system 20; generate a plurality of instruction files based on the information of the plurality of PCIe lanes and store them in the non-transitory computer-readable storage medium, where each instruction file of the plurality of instruction files includes a plurality of test instructions corresponding to the PCIe lanes; and generate an auto-run file based on the plurality of instruction files and store it in the non-transitory computer-readable storage medium, where the auto-run file is used to instruct the test software to execute the plurality of test instructions recorded in each instruction file of the plurality of instruction files.

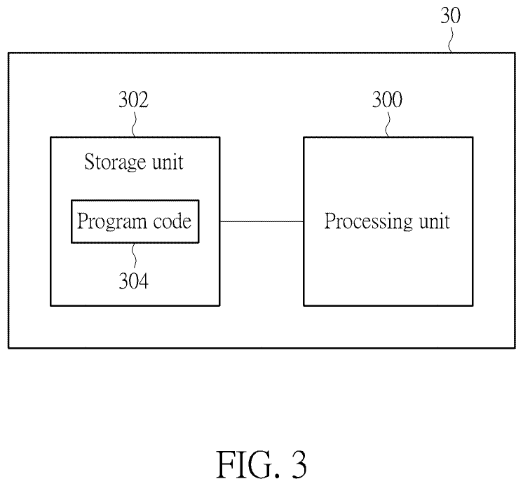

In another embodiment, the operator may control the server system 20 to execute the lane margin testing process 10 through an external device. For example, please refer to FIG. 3, which is a schematic diagram of an electronic device 30 according to an embodiment of the present invention. The electronic device 30 may be a personal computer, tablet computer, laptop, mobile phone, etc., roughly including a processing unit 300 and a storage unit 302. The processing unit 300 may be a general-purpose processor, microprocessor, application-specific integrated circuit, etc., or a combination thereof. The storage unit 302 is coupled to the processing unit 300 and may be any data storage device used to store a program code 304, which is read and executed by the processing unit 300. For example, the storage unit 302 may be read-only memory, flash memory, random access memory, hard disk, optical data storage device, and non-volatile storage unit, etc., but is not limited thereto. In addition, the electronic device 30 may also include wired or wireless communication ports for data exchange with the server system 20 via wired or wireless methods. In such a scenario, the operator may control the server system 20 through the electronic device 30 to execute the lane margin testing process 10 to test the margins of a plurality of PCIe lanes.

Therefore, regardless of whether the server system 20 uses a built-in application or is controlled by an external device to execute the lane margin testing process 10, the non-transitory computer-readable storage medium of the motherboard 200 in the server system 20 should store test software, a plurality of instruction files, and an auto-run file, which are accessed by at least one processor of the server system 20. The plurality of instruction files are generated based on the information of the PCIe lanes to be tested, and each instruction file includes a plurality of test instructions corresponding to the PCIe lanes, while the auto-run file is generated based on the plurality of instruction files and is used to instruct the test software to execute the test instructions recorded in each instruction file. The method for the non-transitory computer-readable storage medium to obtain the test software, instruction files, and auto-run file may be through network download by operator, received from the electronic device 30, or by operator first storing them on an external storage device (such as a USB flash drive) and then connecting the external storage device to the server system 20 to obtain them, and is not limited to these methods. Any appropriate method for obtaining information data may be used in the embodiment of the present invention. Furthermore, the method for the non-transitory computer-readable storage medium to store the test software, instruction files, and auto-run file may be storing them in the same folder, different subfolders of the same folder, different folders, or storing them in the root directory (i.e., the top-level directory of the file system hierarchy), and is not limited thereto. Any appropriate method for storing data required to execute the lane margin testing process 10 is applicable to the embodiment of the present invention.

From the above, it can be seen that the lane margin testing process of the embodiment of the present invention may automatically perform signal integrity testing on multiple PCIe lanes and systematically collect test results, significantly improving testing efficiency and reducing the time and human resources required. The operator only needs to prepare instruction files for each PCIe lane before the test begins and can complete the testing of multiple receivers and their corresponding lanes by executing the auto-run file, without requiring continuous monitoring or re-entering commands, thereby simplifying the operation process. Moreover, the lane margin testing process of the embodiment of the present invention also provides a more organized method for collecting test results, reducing the possibility of errors during result consolidation. Therefore, the present invention addresses the issues of time-consuming, labor-intensive, and human operational errors in the prior art testing methods.

In summary, the present invention not only improves the efficiency of lane margin testing, but also helps engineers more easily identify potential problems, enabling necessary corrections to be made before product launch. It is particularly beneficial for electronic systems, such as server systems, that require large-scale PCIe lane testing.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A lane margin testing method for testing a plurality of Peripheral Component Interconnect Express (PCIe) lanes of an electronic system, comprising:
storing test software in a non-transitory computer-readable storage medium of the electronic system;
generating a plurality of instruction files based on information of the plurality of PCIe lanes and storing the plurality of instruction files in the non-transitory computer-readable storage medium, wherein each instruction file of the plurality of instruction files comprises a plurality of test instructions for a corresponding PCIe lane; and
generating an auto-run file based on the plurality of instruction files and storing the auto-run file in the non-transitory computer-readable storage medium, wherein the auto-run file is used to instruct the test software to execute the plurality of test instructions recorded in each instruction file of the plurality of instruction files.

2. The lane margin testing method of claim 1, wherein the test software supports a Python programming language interpreter.

3. The lane margin testing method of claim 2, wherein the plurality of test instructions conform to Python programming language syntax.

4. The lane margin testing method of claim 1, wherein the plurality of test instructions in each instruction file of the plurality of instruction files comprises first performing a unidirectional test on the corresponding PCIe lane, and then performing a reverse test on the corresponding PCIe lane.

5. The lane margin testing method of claim 1, wherein the plurality of test instructions in each instruction file of the plurality of instruction files comprise generating at least one test result file relative to the corresponding PCIe lane.

6. The lane margin testing method of claim 1, wherein the auto-run file instructs the test software to execute the plurality of test instructions recorded in each instruction file of the plurality of instruction files in a predetermined manner.

7. The lane margin testing method of claim 6, wherein the predetermined manner includes creating a plurality of sessions, with each session used to execute the plurality of test instructions recorded in an instruction file of the plurality of instruction files.

8. The lane margin testing method of claim 6, wherein the predetermined manner is to execute the plurality of test instructions recorded in each instruction file of the plurality of instruction files synchronously or sequentially at a fixed time interval.

9. The lane margin testing method of claim 1, wherein the auto-run file is further used to display test progress in a current terminal, or to generate a notification message when a test for the corresponding PCIe lane is completed.

10. The lane margin testing method of claim 1, wherein the auto-run file is further used to check whether a number of the plurality of PCIe lanes matches a number of the plurality of instruction files, and generate a warning signal when the number of the plurality of PCIe lanes does not match the number of the plurality of instruction files.

11. A non-transitory computer-readable storage medium, for testing a plurality of Peripheral Component Interconnect Express (PCIe) lanes of an electronic system, wherein the non-transitory computer-readable storage medium is accessed by at least a processor, and stores:
test software;
a plurality of instruction files, wherein the plurality of instruction files are generated based on information of the plurality of PCIe lanes, and each instruction file of the plurality of instruction files comprises a plurality of test instructions for a corresponding PCIe lane; and
an auto-run file, wherein the auto-run file is generated based on the plurality of instruction files, and the auto-run file is used to instruct the test software to execute the plurality of test instructions recorded in each instruction file of the plurality of instruction files.

12. The non-transitory computer-readable storage medium of claim 11, wherein the test software supports a Python programming language interpreter.

13. The non-transitory computer-readable storage medium of claim 12, wherein the plurality of test instructions conform to Python programming language syntax.

14. The non-transitory computer-readable storage medium of claim 11, wherein the plurality of test instructions in each instruction file of the plurality of instruction files comprises first performing a unidirectional test on the corresponding PCIe lane, and then performing a reverse test on the corresponding PCIe lane.

15. The non-transitory computer-readable storage medium of claim 11, wherein the plurality of test instructions in each instruction file of the plurality of instruction files comprise generating at least one test result file relative to the corresponding PCIe lane.

16. The non-transitory computer-readable storage medium of claim 11, wherein the auto-run file instructs the test software to execute the plurality of test instructions recorded in each instruction file of the plurality of instruction files in a predetermined manner.

17. The non-transitory computer-readable storage medium of claim 16, wherein the predetermined manner includes creating a plurality of sessions, with each session used to execute the plurality of test instructions recorded in an instruction file of the plurality of instruction files.

18. The non-transitory computer-readable storage medium of claim 16, wherein the predetermined manner is to execute the plurality of test instructions recorded in each instruction file of the plurality of instruction files synchronously or sequentially at a fixed time interval.

19. The non-transitory computer-readable storage medium of claim 11, wherein the auto-run file is further used to display test progress in a current terminal, or to generate a notification message when a test for the corresponding PCIe lane is completed.

20. The non-transitory computer-readable storage medium of claim 11, wherein the auto-run file is further used to check whether a number of the plurality of PCIe lanes matches a number of the plurality of instruction files, and generate a warning signal when the number of the plurality of PCIe lanes does not match the number of the plurality of instruction files.
